(19) United States
(12) Patent Application Publication
(10) Pub. No.: US 2015/0199768 A1
(43) Pub. Date: Jul. 16, 2015

(54) DEPOSIT AND WITHDRAWAL LOG ANALYSIS DEVICE, DEPOSIT AND WITHDRAWAL LOG ANALYSIS METHOD, AND DEPOSIT AND WITHDRAWAL LOG ANALYSIS PROGRAM

(71) Applicant: NEC Corporation, Minato-ku, Tokyo (JP)

(72) Inventors: Kenshi Nishimura, Tokyo (JP); Satoshi Morinaga, Tokyo (JP); Hiroki Nakayama, Tokyo (JP); Kenji Fukuda, Tokyo (JP); Shinichi Toriyama, Tokyo (JP)

(21) Appl. No.: 14/414,262

(22) PCT Filed: Apr. 17, 2013
(86) PCT No.: PCT/JP2013/002590

§ 371 Date: Jan. 12, 2015

(30) Foreign Application Priority Data
Jul. 13, 2012 (JP) 2012-157703

(51) Int. Cl. G06Q 40/00

(52) U.S. Cl. CPC G06Q 40/12

(57) ABSTRACT

A credit and debit log analysis device includes a credit and debit log storage unit (11) that stores a history of credit to an account of a customer to be an analysis object and debit to the account as a credit and debit log, a calendar (15) that stores information on a date, a trend discovering unit (12) that discovers a trend of credit and debit based on the credit and debit log and the calendar, a trend storage unit (13) that stores the trend, a matching rule generating unit (14) that generates a matching rule based on the trend so as to detect credit and debit data contravening the trend, a matching rule storage unit (16) that stores the matching rule, a matching unit (17) that detects a premonition by comparing the credit and debit data and the matching rule, a premonition storage unit (18) that stores the premonition, and a presentation unit (19) that presents the premonition to a user.

### TECHNICAL FIELD

The present invention relates to a credit and debit log analysis device, a credit and debit log analysis method, and a credit and debit log analysis program, by which a premonition useful for grasping a situation of a customer can be obtained through a credit and debit log analysis.

### BACKGROUND ART

PTL 1 discloses a technique, by which bankruptcy probability of a company is calculated using past records, such as account receivable balance, annual trading volume, and mortgage appraisal value, and credit management information including corporate financial data. Further, the technique described in PTL 1 conducts a go/no-go judgment for a transaction according to a predetermined criterion by taking the calculated bankruptcy probability and a profit into consideration.

PTL 2 discloses a technique, by which a final rating value is calculated by administering quantitative information calculated based on financial data and past bankruptcy cases, and corrective information inputted manually by a person in charge of loan, and weighting the two at a predetermined ratio, so as to carry out credit rating on a company accurately.

### CITATION LIST

### Patent Literature

PTL 1: Japanese Unexamined Patent Application Publication No. 2005-258802

PTL 2: Japanese Unexamined Patent Application Publication No. 2005-134938

### SUMMARY OF INVENTION

### Technical Problem

Since the financial data, based on which bankruptcy probability or a rating value used in PTL 1 or PTL 2 is calculated, are macroscopic data, a minute premonition, which may occur in an individual transaction, cannot be grasped. Further, since according to PTL 1 or PTL 2 a qualitative evaluation depending on a subjective opinion of a person in charge is utilized, the evaluation is dependent on the person in charge. Furthermore, there is also a drawback that an evaluation cannot be performed according to PTL 1 or PTL 2, if a person in charge is absent.

Under such circumstances, an object of the present invention is to provide a credit and debit log analysis device, a credit and debit log analysis method, and a credit and debit log analysis program, by which an analysis in minute units not attainable with macroscopic indices can be carried out objectively.

### Solution to Problem

A credit and debit log analysis device according to the present invention includes a credit and debit log storage unit, which stores a history of credit to an account of a customer to be an analysis object and debit to the account as a credit and debit log, a calendar that stores information on a date, a trend discovering unit that discovers a trend of credit and debit based on the credit and debit log and the calendar, a trend storage unit that stores the trend, a matching rule generating unit that generates a matching rule based on the trend so as to detect credit and debit data contravening the trend, a matching rule storage unit that stores the matching rule, a matching unit that detects a premonition by comparing the credit and debit data and the matching rule, a premonition storage unit that stores the premonition, and a presentation unit that presents the premonition to a user.

A credit and debit log analysis method according to the present invention includes storing a history of credit to an account of a customer to be an analysis object and debit to the account as a credit and debit log, storing information on a date in a calendar, discovering a trend of credit and debit based on the credit and debit log and the calendar, string the trend, generating a matching rule based on the trend so as to detect credit and debit data contravening the trend, storing the matching rule, detecting a premonition by comparing the credit and debit data and the matching rule, storing the premonition, and presenting the premonition to a user.

A credit and debit log analysis program according to the present invention causes a computer to execute a credit and debit log storage processing for storing a history of credit to an account of a customer to be an analysis object and debit to the account as a credit and debit log, a processing for storing information on a date in a calendar, a trend discovery processing for discovering a trend of credit and debit based on the credit and debit log and the calendar, a trend storage processing for storing the trend, a matching rule generation processing for generating a matching rule based on the trend so as to detect credit and debit data contravening the trend, a matching rule storage processing for storing the matching rule, a matching processing for detecting a premonition by comparing the credit and debit data and the matching rule, a premonition storage processing for storing the premonition, and a presentation processing for presenting the premonition to a user.

### Advantageous Effects of Invention

According to the present invention, an analysis in minute units not attainable with macroscopic indices can be carried out objectively.

### BRIEF DESCRIPTION OF DRAWINGS

FIG. 1 is a block diagram showing a constitution of a first exemplary embodiment of a credit and debit log analysis device according to the present invention.

FIG. 2 is a flow chart showing actions required for generation of a matching rule from a credit and debit log.

FIG. 3 is a flow chart showing actions required for detecting a premonition from a newly generated credit and debit log.

FIG. 4 is an explanatory chart showing data stored in a credit and debit log storage unit of an example.

FIG. 5 is an explanatory chart showing a trend discovered by a trend discovering unit of the example.

FIG. 6 is an explanatory chart showing a matching rule stored in a matching rule storage unit of the example.

FIG. 7 is an explanatory chart showing data stored in a premonition storage unit of the example.

FIG. 8 is an explanatory chart showing another example of a trend discovered by a trend discovering unit.

FIG. 9 is an explanatory chart showing another example of a matching rule stored in a matching rule storage unit.

FIG. 10 is a block diagram showing a constitution of a second exemplary embodiment of a credit and debit log analysis device according to the present invention.

FIG. 11 is an explanatory chart showing an example of a credit and debit log storage unit provided with a column with respect to a payment means.

FIG. 12 is a block diagram showing a constitution of a third exemplary embodiment of a credit and debit log analysis device according to the present invention.

FIG. 13 is a block diagram showing another exemplary constitution of the third exemplary embodiment of the credit and debit log analysis device.

FIG. 14 is a block diagram showing still another exemplary constitution of the third exemplary embodiment of the credit and debit log analysis device.

FIG. 15 is a block diagram showing an example of a display by a presentation unit of a fourth exemplary embodiment.

FIG. 16 is a block diagram showing a credit and debit log analysis device connected with a network.

### DESCRIPTION OF EMBODIMENTS

Exemplary embodiments of the present invention will be described in detail below referring to drawings.

### Exemplary Embodiment 1

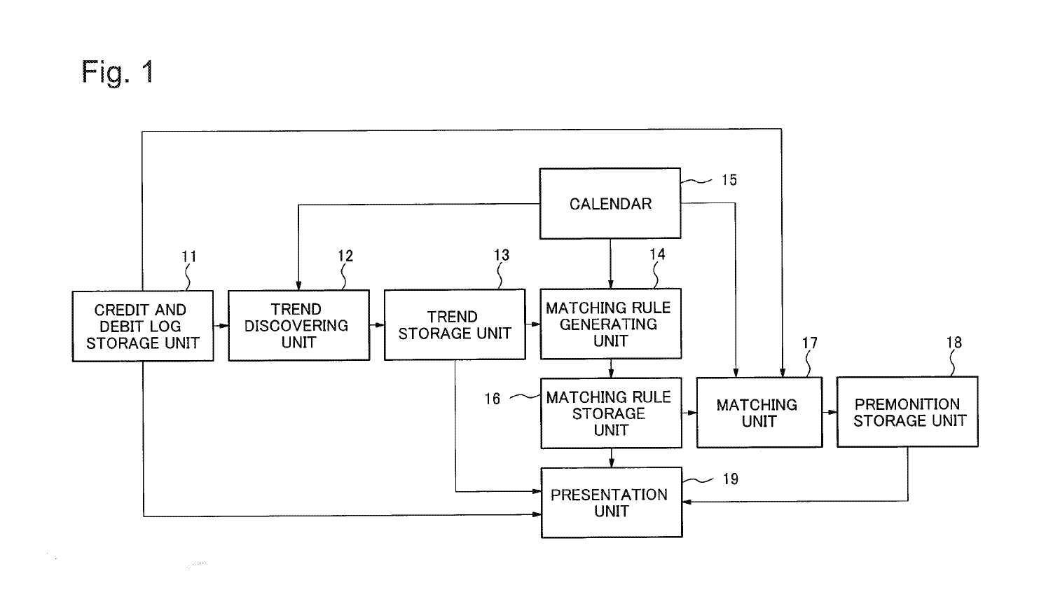

FIG. 1 is a block diagram showing a constitution of the first exemplary embodiment (Exemplary Embodiment 1) of a credit and debit log analysis device according to the present invention. As shown in FIG. 1, a credit and debit log analysis device of the present exemplary embodiment includes a credit and debit log storage unit 11, a trend discovering unit 12, a trend storage unit 13, a matching rule generating unit 14, a calendar 15, a matching rule storage unit 16, a matching unit 17, a premonition storage unit 18, and a presentation unit 19.

The credit and debit log storage unit 11 stores a history of credit to an account of a customer to be an analysis object (e.g. a company or an individual) and a payment from the account. The trend discovering unit 12 discovers a trend in the credit and debit, such as regularly occurring credit and debit, referring to the credit and debit log stored in the credit and debit log storage unit 11 and the information concerning a date stored in the calendar 15. The trend storage unit 13 stores the trend of the credit and debit discovered by the trend discovering unit 12. The matching rule generating unit 14 generates a matching rule based on the trend of the credit and debit so as to detect credit and debit data contravening the trend.

The calendar 15 stores information concerning date (e.g. in the order of year, month, and day). The matching rule storage unit 16 stores a matching rule generated by the matching rule generating unit 14. The matching unit 17 compares each of the credit and debit data stored in the credit and debit log storage unit 11 with the matching rule stored in the matching rule storage unit 16. In the event there is a credit and debit datum contravening the matching rule, the matching unit 17 stores the same as a premonition showing company deterioration, etc. in the premonition storage unit 18.

The premonition storage unit 18 stores a premonition detected by the matching unit 17. The presentation unit 19 presents to a user the credit and debit log stored in the credit and debit log storage unit 11, the trend stored in the trend storage unit 13, the matching rule stored in the matching rule storage unit 16, and the premonition stored in the premonition storage unit 18. The presentation unit 19 does not necessarily present all of the above, but may present, for example, only the premonition.

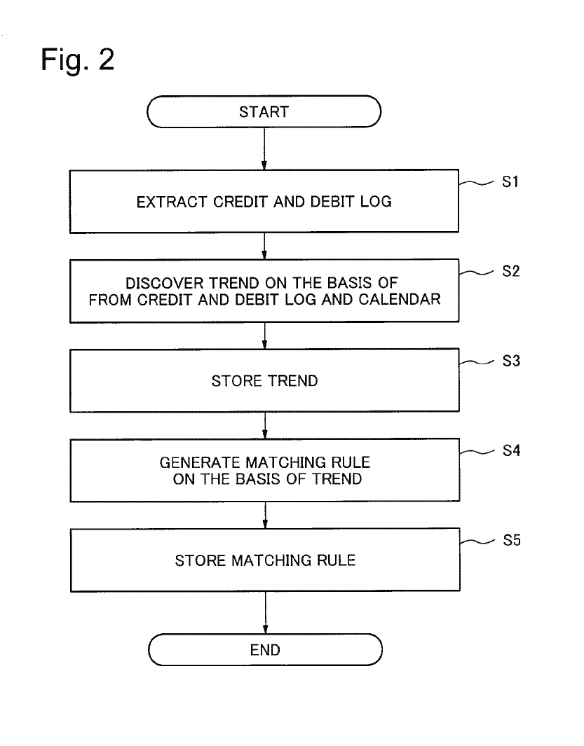

Next, actions of a credit and debit log analysis device of the present exemplary embodiment will be described. FIG. 2 is a flow chart showing actions required for generation of a matching rule from a credit and debit log.

The trend discovering unit 12 extracts a credit and debit log to be used for discovering a trend from the credit and debit log storage unit 11 (step S1). Then, the trend discovering unit 12 discovers a trend on the basis of the extracted credit and debit log and the date information in the calendar 15 (step S2). Then, the trend discovering unit 12 stores the discovered trend in the trend storage unit 13 (step S3).

Next, the matching rule generating unit 14 generates a matching rule on the basis of the discovered trend and a date in the calendar 15 (step S4). Then, the matching rule generating unit 14 stores (saves) the matching rule in the matching rule storage unit 16 (step S5).

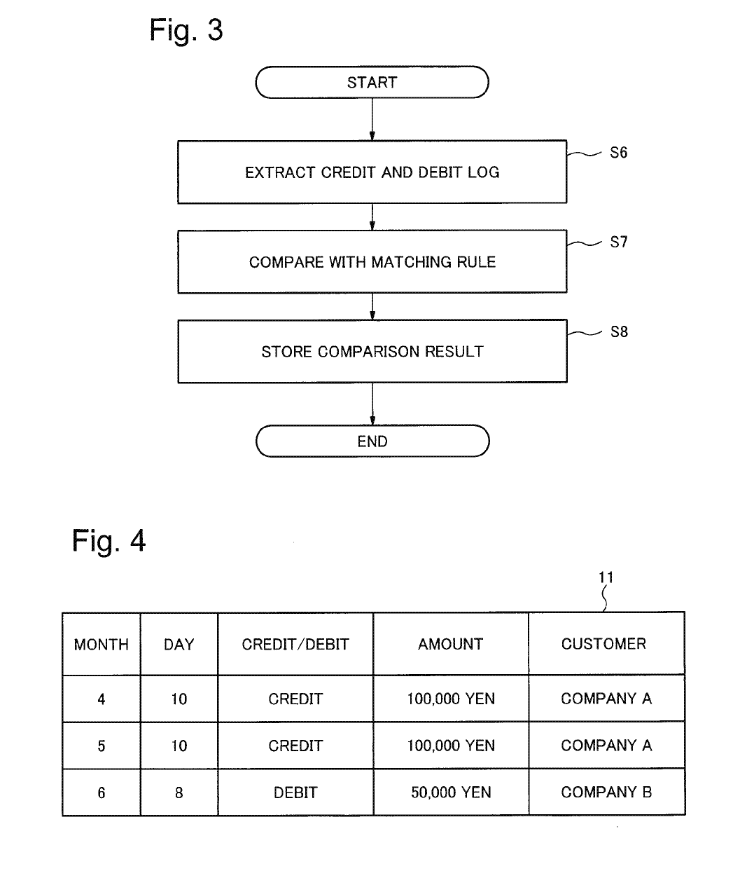

FIG. 3 is a flow chart showing actions required for detecting a premonition from a newly generated credit and debit log. The matching unit 17 extracts a credit and debit log as an object of an analysis from the credit and debit log storage unit 11 referring to the matching rule and the date in the calendar 15 (step S6). Then, the matching unit 17 compares the extracted credit and debit log with the matching rule stored in the matching rule storage unit 16 (step S7). Then, the matching unit 17 stores the comparison results in the premonition storage unit 18 (step S8).

Operations of an example of a credit and debit log analysis device of the present exemplary embodiment will be described below. FIG. 4 is an explanatory chart showing a credit and debit log stored in the credit and debit log storage unit 11 of the Example. The credit and debit log shown in FIG. 4 records when, with whom, and in what amount a transaction is conducted. The credit and debit log records further whether crediting or debiting took place.

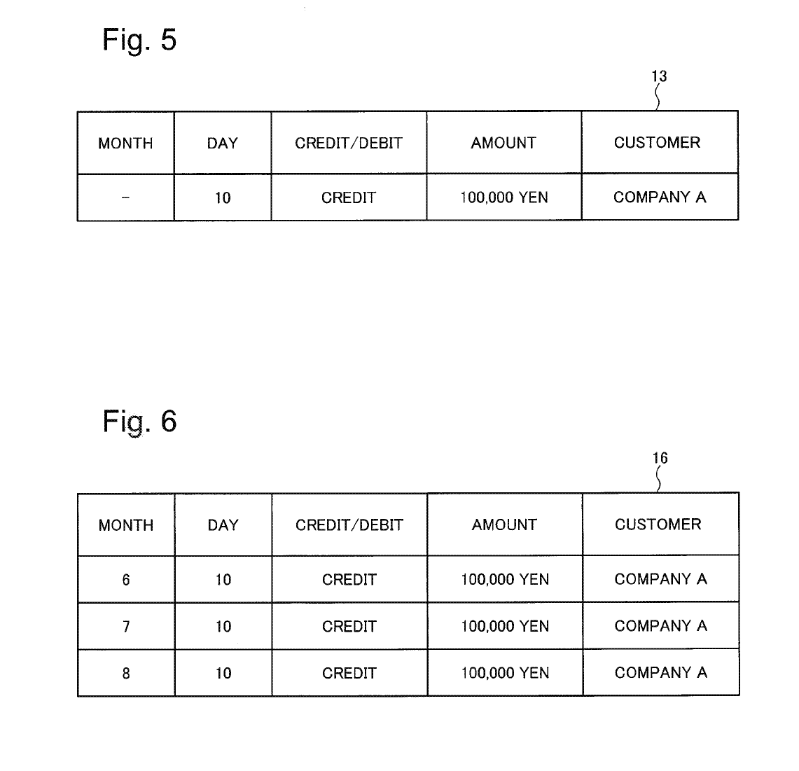

FIG. 5 is an explanatory chart showing a trend discovered by a trend discovering unit of the example. From the credit and debit log shown in FIG. 4 the trend discovering unit 12 discovers a trend that 100,000 yen is received from Company A on the 10th day of each month. Then, the trend that 100,000 yen is received from Company A on the 10th day of each month is stored in the trend storage unit 13 as shown in the second row of the table in FIG. 5.

FIG. 6 is an explanatory chart showing a matching rule stored in a matching rule storage unit of the Example. In the table shown in FIG. 6, a matching rule that 100,000 yen is received from Company A on June 10, July 10, and August 10, is presented. The matching rule generating unit 14 generates a matching rule as presented in FIG. 6 referring to the trend shown in FIG. 5 and the information in the calendar 15.

In order to discover a trend from the credit and debit log, the trend discovering unit 12 counts for example the number of combinations of the respective data in the credit and debit log, and a trend is discovered if there is the same combination occurring not less than a predefined number of times. For example, in the case of the example shown in FIG. 4, a combination “that 100,000 yen is received from Company A on the 10th day” appears twice. Since there is no other combination that appears twice, the combination that appears twice is stored as a trend.

In discovering a trend, the trend discovering unit 12 may take the likelihood of the trend into consideration. For example, comparing a case in which a credit is earned on the 10th day of each month over 12 months, and a case in which a credit is earned on the 10th day in 9 months out of 12 months, the former case exhibits higher likelihood. Further, even in the latter case, the likelihood is different, if the remaining 3 credits are absent at all, or made on different days. For the trend discovering unit 12, a frequency of credit and debit data per certain period that correspond to a trend, or a frequency of exceptions may be decided in advance, and a trend which satisfies the condition may be only extracted.

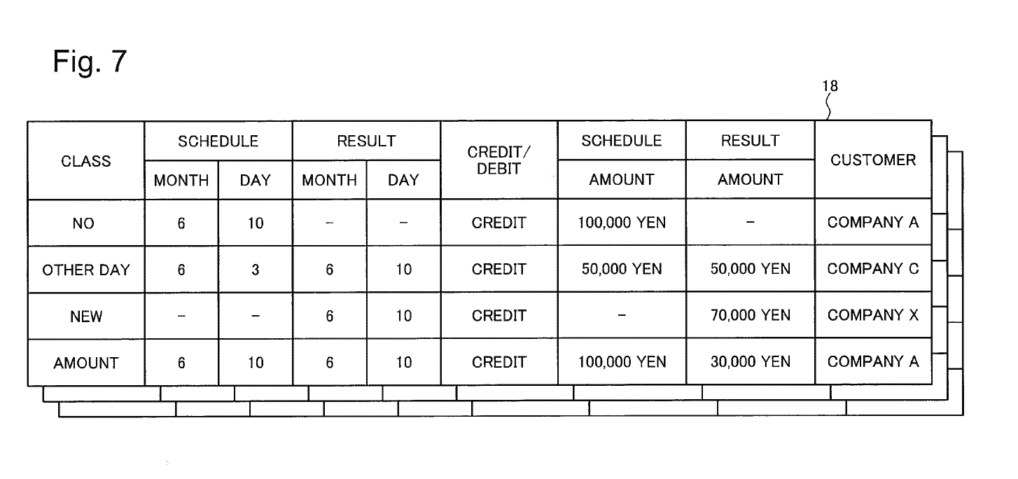

FIG. 7 is an explanatory chart showing data stored in a premonition storage unit of the example. The data shown in the second row of FIG. 7, in which “No” is entered in the column of Class, indicates that a credit scheduled on June 10 has not been actually earned. In detecting the data in the second row of FIG. 7, the matching unit 17 compares the entire credit and debit logs of June 10 with a matching rule for June 10, and in the event that there exists no data satisfying the matching rule in the logs, a record with an entry of “No” is stored in the premonition storage unit 18. When a similar premonition with respect to a debit is detected, a user may presume, for example, that the company has suddenly suspended paying a bonus, which has been paid every year. Similarly, a user can detect, for example, that expenses for rent of land and space, which have been paid every year, have been suddenly abolished. In the latter case, it is possible to presume that an office is closed in connection with corporate restructuring.

The data shown in the third row in FIG. 7, in which “Other day” is entered in the column of Class, indicates that a credit scheduled on a day other than June 10 was earned actually on June 10. In detecting the data in the third row of FIG. 7, the matching unit 17 compares the entire credit and debit logs of June 10 with all the matching rules from June 10 retroactively for a month, and in the event that there exists an applicable rule in the logs, a record with an entry of “Other day” in Class is stored in the premonition storage unit 18.

The data shown in the fourth row in FIG. 7, in which “New” is entered in the column of Class, indicates that a credit is earned on June 10 newly from a company without any past record of crediting. In detecting the data in the fourth row of FIG. 7, the matching unit 17 compares the entire credit and debit logs of June 10 with all the matching rules of June 10 and before, and in the event that there exists no applicable rule in the logs, a record with an entry of “New” in Class is stored in the premonition storage unit 18. Another method may be also applied, by which a table containing only companies with a past record of crediting is generated by the matching rule generating unit 14 and stored in the matching rule storage unit 16, and the matching unit 17 checks the credit and debit log referring to the table.

The data shown in the fifth row in FIG. 7 indicates that a scheduled credit was earned on June 10, however the amount was different. In detecting the data in the fifth row of FIG. 7, the matching unit 17 compares the amount of the matching rule with the amount of the credit and debit log. In the event such a premonition concerning the payment amount is presented, a user can detect, for example, that a company disbursed in a certain month excessive retirement allowances. In such a case it is possible that the customer of the analysis object may have invited employees to early retirement.

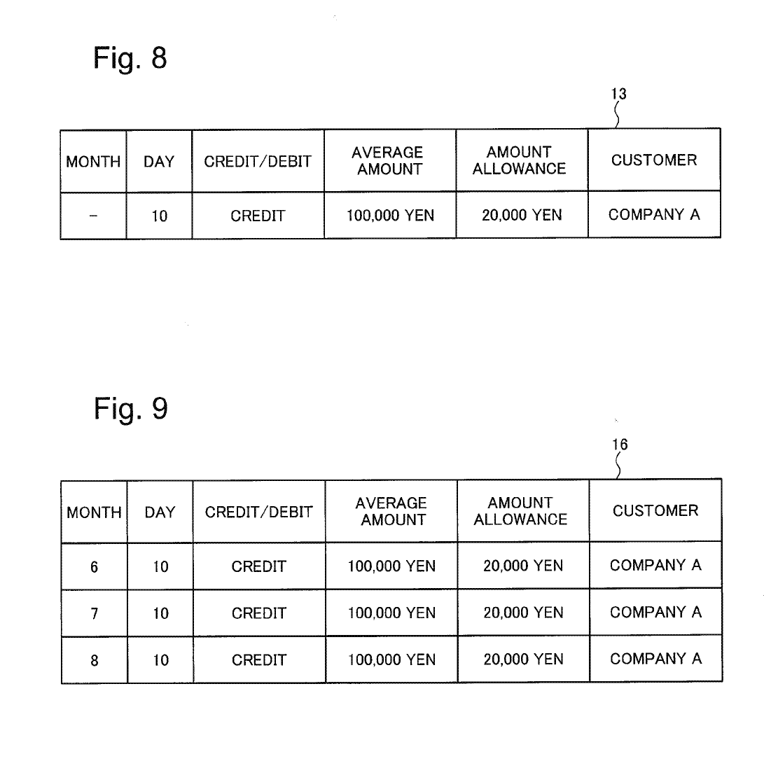

FIG. 8 is an explanatory chart showing another example of a trend discovered by the trend discovering unit 12. FIG. 9 is an explanatory chart showing another example of a matching rule stored in a matching rule storage unit. In the examples shown in FIG. 8 and FIG. 9, in contrast to those in FIG. 5 and FIG. 6, the trend is expressed with some allowance of the amount. In FIG. 8 and FIG. 9, it is shown that the amount is 100,000 yen ±20,000 yen. The trend discovering unit 12 calculates, for example, the average and the standard deviation of the amounts in the credit and debit log, and generates data shown in the second row in FIG. 8 based on the average and the standard deviation. The matching rule generating unit 14 may generate a matching rule as in FIG. 9 using the allowance of the amount in FIG. 8 as it is, or use the range of 2-fold or 3-fold of the standard deviation as the allowance of the amount for a matching rule.

In this regard, the trend discovering unit 12 may adopt an on-line processing, by which upon entry of a new piece of data in the credit and debit log, the same is compared, or adopt a batch-wise processing, by which all the data entered during a certain period are compared collectively. In the case of a batch-wise processing, the trend discovering unit 12 conducts a comparison at one time, for example, when the credit and debit logs for a whole day have been collected. Further, the trend discovering unit 12 may conduct an on-demand processing, by which it initiates a comparison upon receipt of a demand from a user or an external system. The matching unit 17 may adopt similarly as the trend discovering unit 12 any of an on-line processing, a batch-wise processing, and an on-demand processing.

Since, as described above, the credit and debit log analysis device according to the present exemplary embodiment analyzes directly primary data of the credit and debit log, an analysis in minute units, which cannot be grasped from macroscopic indices, becomes possible. Furthermore, since the credit and debit log analysis device according to the present exemplary embodiment conducts an analysis by a computer based on objective criteria, there is no room for a subjective opinion of a person in charge, and an analysis of a customer is possible in the absence of a person in charge.

Since the credit and debit log analysis device according to the present exemplary embodiment conducts an analysis not manually but by a computer, the cost can be reduced. Furthermore, since the credit and debit log analysis device according to the present exemplary embodiment uses objective criteria generated from past credit and debit logs, the criteria are not biased by personal preconceptions and an overlook of a premonition can be prevented. Further, since the credit and debit log analysis device according to the present exemplary embodiment can store an analysis result electronically, the analysis result can be easily reused.

Further, with the credit and debit log analysis device according to the present exemplary embodiment, the time and labor required for detecting an irregular transaction deviating from regular and ordinary transactions among credit and debit transactions of a customer, especially at a financial institution, can be curtailed. Further, with the credit and debit log analysis device according to the present exemplary embodiment, the detected irregular transactions can be collected, shared, and reused among interested persons. Meanwhile, since the credit and debit log analysis device according to the present exemplary embodiment can contribute to grasp a premonition of company deterioration, for example, by a financial institution, an early stage protective measure can be employed by grasping at an early stage a premonition of company deterioration.

### Exemplary Embodiment 2

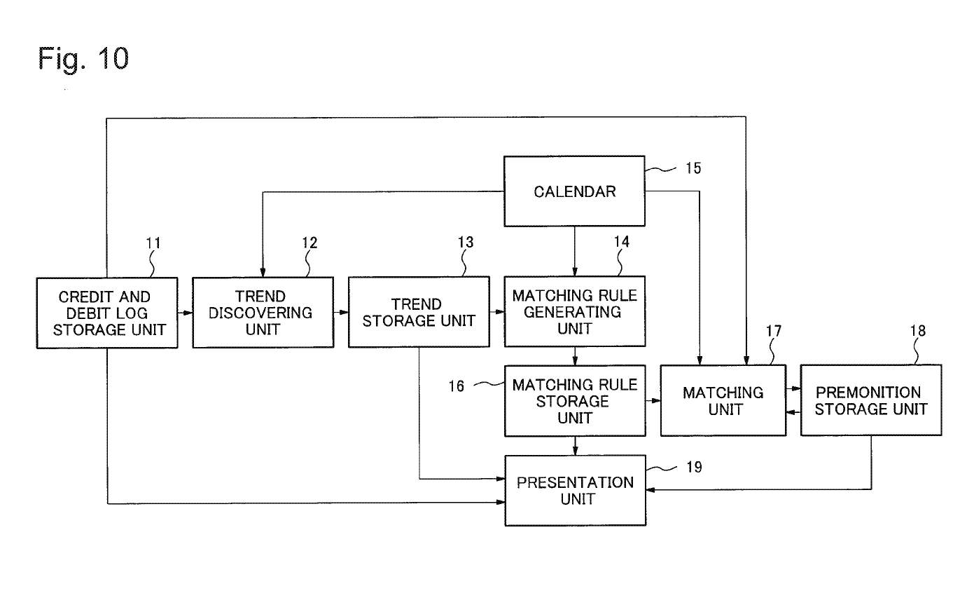

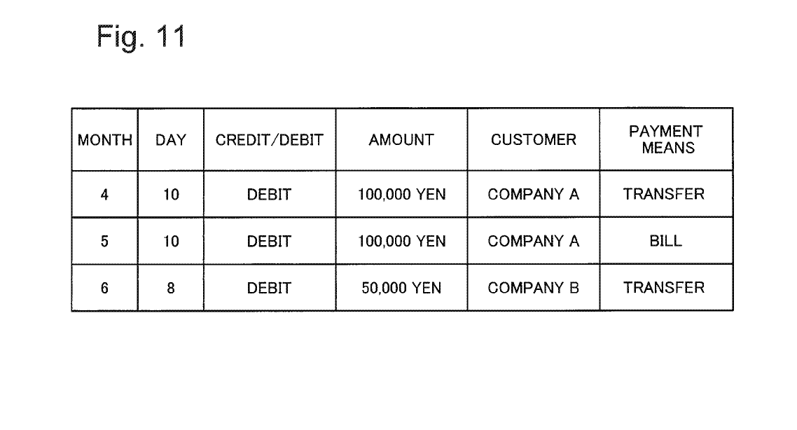

FIG. 10 is a block diagram showing a constitution of the second exemplary embodiment (Exemplary Embodiment 2) of a credit and debit log analysis device according to the present invention. The constitution shown in FIG. 10 is identical with the constitution of the first exemplary embodiment shown in FIG. 1, except that there is an arrow showing a flow of a past premonition from the premonition storage unit 18 to the matching unit 17. It means that, according to the present exemplary embodiment, the matching unit 17 detects a new premonition by tracing back to past premonitions stored in the premonition storage unit 18.

According to the present exemplary embodiment, it is possible to determine whether premonitions of the same Class have been detected a predetermined number of times successively. For example, in a case where the matching unit 17 stores a premonition lacking for a credit as the data shown in the second row of FIG. 7, similar premonitions (not illustrated) in the past, for example, on May 10, April 10 are searched, and if credits are also lacking, then successive 3 similar premonitions are searched. The matching unit 17 detects the above as a new premonition. In this case it is shown that crediting stopped suddenly in April, which has continued for 3 months.

The credit and debit log analysis device according to the present exemplary embodiment can detect if the intervals between credits increase gradually. For example, if the matching unit 17 stores a premonition that the result is later than a scheduled date for a credit as the data shown in the third row of FIG. 7, similar premonitions in the past (not illustrated) are searched. Namely, in a case, for example, where a scheduled date for a credit is the 3rd day of each month and actual credit dates are April 5 and May 8, the gradual shift (delay) of actual credit dates is detected as a new premonition.

Further, the credit and debit log analysis device according to the present exemplary embodiment can detect also, for example, if the credit amount decreases gradually, or conversely increases gradually. In the event the matching unit 17 detects a premonition that a credit amount is less than a scheduled amount as shown in the fifth row of FIG. 7, the unit searches a past similar premonition (not illustrated). As the result, for example, if the credit amount in April was 80,000 yen, and the credit amount in May was 60,000 yen, a new premonition that the actual amount is changing (decreasing) gradually is detected.

Further, the credit and debit log analysis device according to the present exemplary embodiment can also detect a monthly credit of a substantially same amount or an amount in a round number from a customer, with whom dealing has started newly since a certain month. Since such a transaction may possibly be a bogus transaction, it may be deemed as a premonition to be detected.

Further, the credit and debit log analysis device according to the present exemplary embodiment can detect that payments performed to a certain customer by a certain means until a certain month have been changed to another means since the certain month. For example, a fact that the payment performed initially by a transfer was changed to a payment by a bill payable from a certain time point suggests a tighter cash-flow, which may be a premonition to be detected. In order to make such detection possible, it is necessary for the credit and debit log storage unit 11, the trend storage unit 13, the matching rule storage unit 16, and the premonition storage unit 18 to store information on a payment means, and specifically they should be provided with a column with respect to a payment means.

FIG. 11 is an explanatory chart showing an example of a credit and debit log storage unit 11 provided with a column with respect to a payment means. As shown in FIG. 11, the means of a monthly payment of 100,000 yen to Company A has been changed from transfer to bill. For example, in a case where the payment means of a matching rule is transfer, the matching unit 17 detects the data in the third row in which the payment is by “bill” as a premonition. In this regard, when a change in a payment means is to be detected, it seems useful for improvement of detection accuracy to add a condition, for example, that the amounts are almost same.

Further, the credit and debit log analysis device according to the present exemplary embodiment can collect monthly changes in transaction amounts with a certain customer or the total transaction amounts with the entire customers for several years, and detect if the change exceeds a certain value. For example, a case, where transaction amounts with a customer have been about 1 hundred million yen/month in January, February, and March respectively in the recent years, and transaction amounts have been about 1 billion yen/month in April, May, and June respectively in the recent years, is assumed. In such a case, the credit and debit log analysis device according to the present exemplary embodiment may take it for normal that the transaction amount increases suddenly in April, but for abnormal that the same increases suddenly in February. According to the present exemplary embodiment, the totalizing period may be not only a month but may be a day, a week, or the like.

Further, in the credit and debit log analysis device according to the present exemplary embodiment the matching unit 17 can evaluate the condition of a customer to be an analysis object based on a plurality of premonitions stored in the premonition storage unit 18. For example, when the monthly number of premonitions increases gradually, the credit and debit log analysis device according to the present exemplary embodiment can decide that the condition of a customer to be an analysis object has been deteriorating. Further, when the number of premonitions increases suddenly in a certain month, the credit and debit log analysis device according to the present exemplary embodiment will evaluate that the business performance has been rapidly deteriorated. The matching unit 17 stores also the evaluation result in the premonition storage unit 18. The matching unit 17 can achieve such an evaluation, for example, by labelling premonitions on which the evaluation is based. Further, the credit and debit log analysis device according to the present exemplary embodiment can detect a change in the number of specific credits and debits per month. For example, in the case of a corporation and if the corporate tax is paid twice in a month, it is possible that an overdue tax or a surcharge was demanded.

### Exemplary Embodiment 3

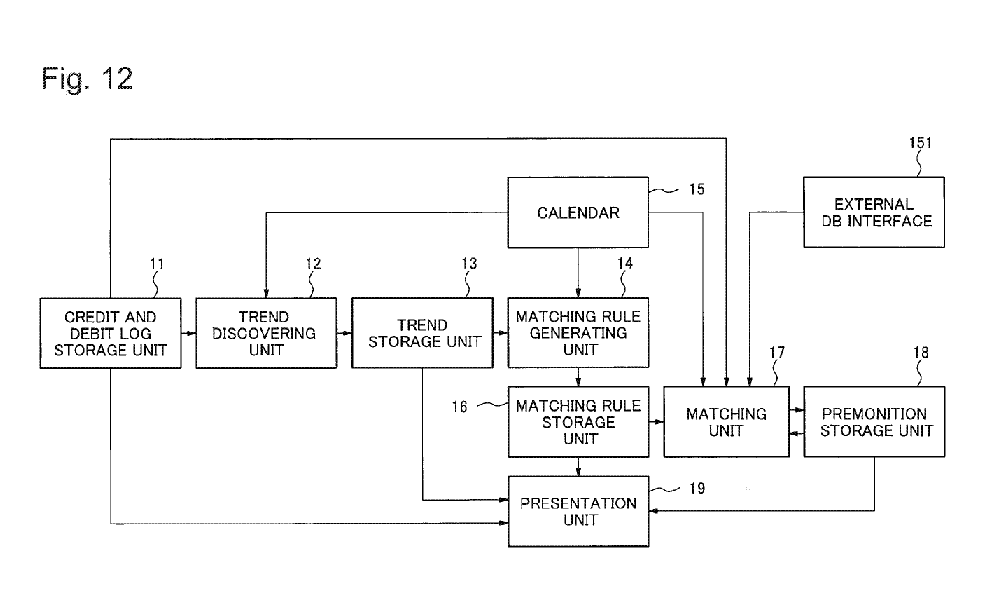

FIG. 12 is a block diagram showing a constitution of the third exemplary embodiment (Exemplary Embodiment 3) of a credit and debit log analysis device according to the present invention. The credit and debit log analysis device according to the present exemplary embodiment shown in FIG. 12 is configured such that an external database (DB: DataBase) interface 151 is added to the credit and debit log analysis device according to the second exemplary embodiment shown in FIG. 10.

In the credit and debit log analysis device according to the present exemplary embodiment the matching unit 17 detects a premonition by obtaining data of an external database through the external DB interface 151 and combining the same with the data in the premonition storage unit 18. The data in the external database (external data) are data other than a credit and a debit of a company of an analysis object. For example, the matching unit 17 can detect a payment in an amount equal to or more than 30% of the annual sales volume by obtaining external data showing the company size, such as the capital size and the annual sales volume, from an external database. If such a detection is made, it is possible that a bogus transaction has been undertaken.

Further, the credit and debit log analysis device according to the present exemplary embodiment can detect an abnormal payment of a tax, for example, by obtaining account settlement data from an external database. For example, in the event that a company in deficit pays a corporate tax, or that a company does not pay a corporate tax even 5 years after return into profit from deficit, the event is abnormal and detected as a premonition.

With the credit and debit log analysis device according to the present exemplary embodiment, a preventive effect against overlook and negligence in notification of a premonition can be improved by utilizing data of an external database.

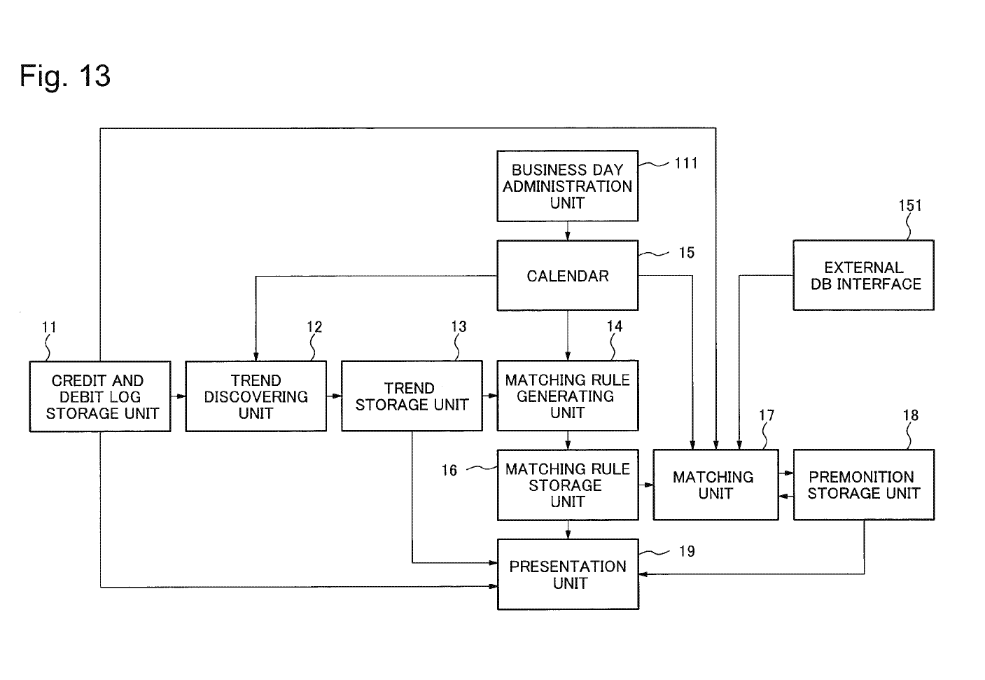

FIG. 13 is a block diagram showing another exemplary constitution of the third exemplary embodiment of the credit and debit log analysis device. The credit and debit log analysis device shown in FIG. 13 is configured such that a business day administration unit 111 connected with the calendar 15 is added to the constitution shown in FIG. 12. Further, the credit and debit log analysis device of the present Example may have an exemplary constitution, in which a business day administration unit 111 is added to the constitution shown in FIG. 1 or FIG. 10. The business day administration unit 111 contains information concerning business days, on which a credit and a debit can be earned. In this regard, for example, a day on which the company of an analysis object is doing business, but banks are closed, is not deemed as a business day, because crediting and debiting are not possible.

The credit and debit log analysis device according to the present exemplary embodiment can perform discovery of a trend, generation of a matching rule, and comparison, considering a non-business day. For example, in a case where it is assumed that the business day administration unit 111 maintains a rule, by which, if a scheduled date for crediting is a holiday, crediting will possibly occur on the next business day. In such a case, if June 10 is a Sunday or a holiday and a credit and a debit are not entered, the credit and debit log analysis device according to the present exemplary embodiment interprets a credit entered on June 11 as a credit on June 10. Meanwhile, for example, in a case where it is assumed that the business day administration unit 111 maintains a rule, by which, if a scheduled date for crediting is a holiday, crediting will possibly occur on the previous business day. In such a case, if June 10 is a Saturday and a credit and a debit are not entered, the credit and debit log analysis device according to the present exemplary embodiment interprets a credit entered on June 9 as a credit on June 10.

The credit and debit log analysis device shown in FIG. 13 can discover a trend of regular credits and debits at the beginning of a month, the end of a month, or the like, in a case where the business day administration unit 111 administers the beginning of a month, the end of a month, etc. in the calendar 15. For example, a case where there is a regular credit at the end of a month is assumed. In such a case, since a credit is earned on the 30th day or on the 31st day depending on the month, the credit and debit log analysis device cannot decide solely by date information whether a credit is a regular one or not. Therefore, in such a case, insofar as dates of the end of every month are administered, the credit and debit log analysis device can decide whether there is a regular credit at the end of a month. Further, the credit and debit log analysis device can discover a trend with respect to credits and debits, for example, at the beginning or the end of a term, every 2 months, every 3 months, on a specific day of the week, in a specific month, on the 3rd Monday, etc. by using the business day administration unit 111.

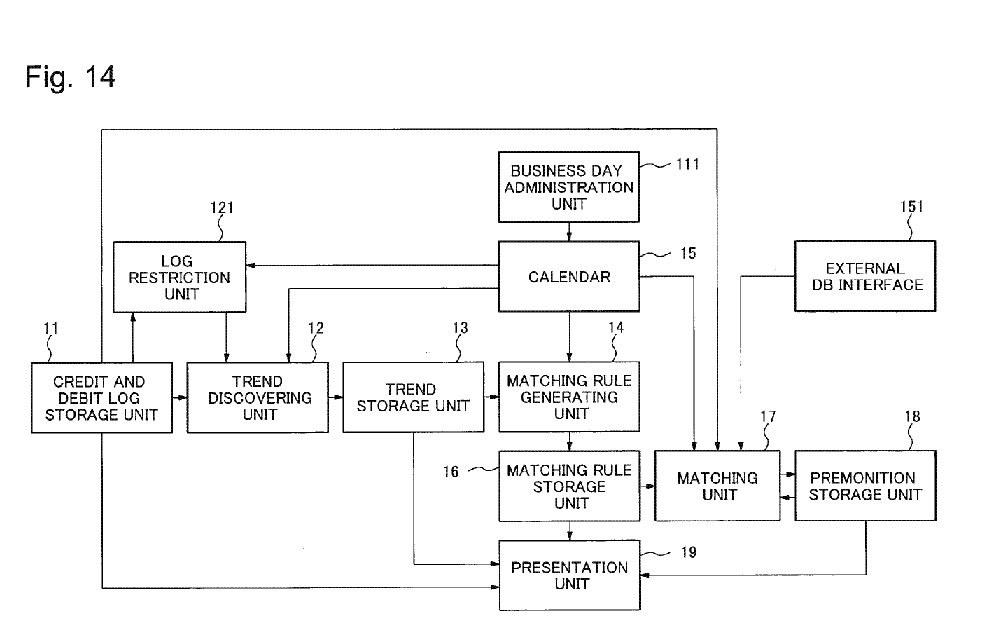

FIG. 14 is a block diagram showing still another constitution of the third exemplary embodiment of the credit and debit log analysis device. The credit and debit log analysis device shown in FIG. 14 is configured such that a log restriction unit 121 is added to the constitution shown in FIG. 13. Meanwhile, the credit and debit log analysis device of the present Example may be configured such that the business day administration unit 111 is added to the constitution shown in FIG. 1 or FIG. 10. The credit and debit log analysis device shown in FIG. 14 restricts logs, when the trend discovering unit 12 extracts a log from the credit and debit log storage unit 11. The trend discovering unit 12 restricts credit and debit logs as an analysis object in terms of, for example, a period, discrimination between a credit and a debit, an amount, a customer, etc.

The credit and debit log analysis device shown in FIG. 14 may import information on a customer, such as a transaction amount, from an external system through the external DB interface, and restrict credit and debit data based thereon. When the matching unit 17 extracts a log from the credit and debit log storage unit 11, a log restriction unit 121 may intervene therein for restricting a log to be extracted.

### Exemplary Embodiment 4

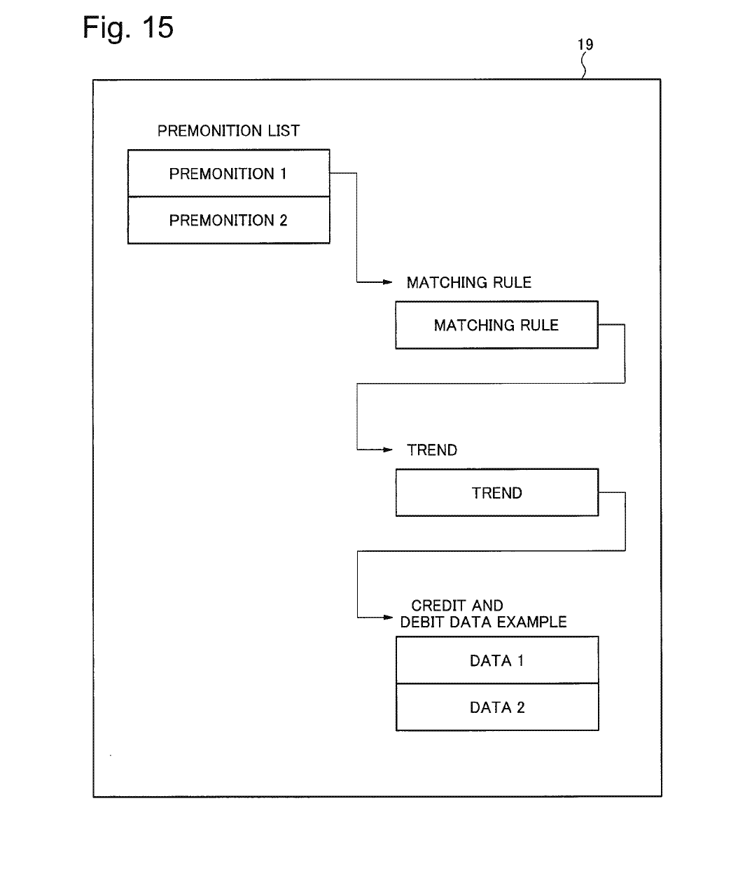

FIG. 15 is a block diagram showing an example of a display by a presentation unit 19 of the fourth exemplary embodiment. The presentation unit 19 displays a premonition list of premonitions extracted from the premonition storage unit 18. The content of the premonition list is for example data shown in FIG. 7. When a user designates a specific premonition, a matching rule based on which the premonition was detected is displayed. The content of the matching rule is for example data shown in FIG. 6 or FIG. 9. When a user designates a matching rule, a trend based on which the matching rule was generated is displayed. The content of the trend to be displayed is for example as shown in FIG. 5 or FIG. 8. When a user designates a trend, a part of the credit and debit data based on which the trend was discovered is displayed. The content of the credit and debit data to be displayed is for example as shown in FIG. 4.

Further, when a user specifies a premonition, the presentation unit 19 may display a past premonition, which was detected based on the same matching rule by which the specified premonition was detected.

When a user specifies a matching rule, the presentation unit 19 may display a past premonition, which was detected by the same matching rule. Alternatively, as soon as the matching unit 17 detects a premonition, the presentation unit 19 may display the premonition. The presentation unit 19 does not ordinarily display a premonition, and may display a premonition only when an instructed is made by a user. Further, the presentation unit 19 may have a user search a past premonition, and display the result. The presentation unit 19 may display the change in the number of detected premonitions as a table or a graph.

The presentation unit 19 may allow a user to input a judgment whether a premonition is useful or not, and display selectively a premonition, for which a positive judgment has been inputted. Further, it is conceivable that the presentation unit 19 is so configured as to cumulate or classify only useful premonitions. In this regard, a useful premonition means, for example, in the case of a company, a premonition related to company deterioration.

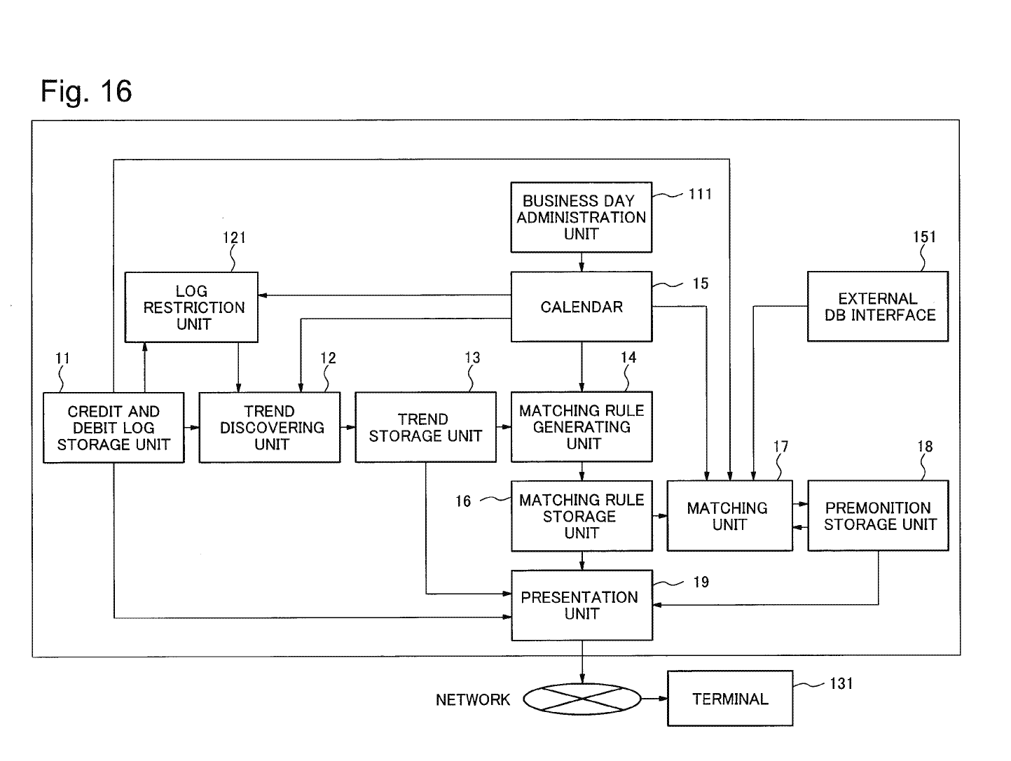

FIG. 16 is a block diagram showing a credit and debit log analysis device connected with a network. The presentation unit 19 may transmit a presenting content to a terminal 131 through a network, and present the same by an e-mail or a pop-up to all interested persons having a terminal 131. Alternatively, by combining the credit and debit log analysis device with a printing system, the presentation unit 19 may inform the presenting content to the interested persons by mail.

The presentation unit 19 may transmit a premonition only to the terminal 131 of interested persons defined for each condition of a premonition, such as a transaction partner and an amount. Further, the presentation unit 19 may inform publicly by a warning light that there is a noteworthy presenting content, when a predetermined condition, such as an amount and a transaction partner, is met.

The presentation unit 19 may be configured such that a premonition, a matching rule, a trend, and a credit and debit log once displayed can be searched and displayed later. An example of the presentation unit 19 shown in FIG. 16 can display data on demand at an office such as headquarters apart from a job site of a credit and debit log analysis through a network.

Since the credit and debit log analysis device shown in FIG. 16 notifies a premonition electronically to predetermined addresses, it exhibits an effect that negligence in notification can be avoided.

In the aforedescribed exemplary embodiments, the credit and debit log analysis devices referred to in the following (1) to (8) and (Supplementary Note 1) to (Supplementary Note 15) are also disclosed.

(1) A credit and debit log analysis device is provided with the following:

a credit and debit log storage unit, which stores a history of credit to an account of a customer to be an analysis object and debit to the account as a credit and debit log (e.g. credit and debit log storage unit 11),

a calendar, which stores information on a date (e.g. calendar 15),

a trend discovering unit, which discovers a trend of credit and debit based on the credit and debit log and the calendar (e.g. trend discovering unit 12),

a trend storage unit, which stores the trend (e.g. trend storage unit 13),

a matching rule generating unit, which generates a matching rule based on the trend so as to detect credit and debit data contravening the trend (e.g. matching rule generating unit 14),

a matching rule storage unit, which stores the matching rule (e.g. matching rule storage unit 16),

a matching unit, which detects a premonition by comparing the credit and debit data and the matching rule (e.g. matching unit 17),

a premonition storage unit, which stores the premonition (e.g. premonition storage unit 18), and

a presentation unit, which presents the premonition to a user (e.g. presentation unit 19).

(2) The credit and debit log analysis device may be configured such that the trend discovering unit discovers a trend that a credit or a debit occurs on a specific day, and the matching unit detects that a credit or a debit has not occurred on the specific day as a premonition.
(3) The credit and debit log analysis device may be configured such that the trend discovering unit discovers a trend that credit and debit occur in an amount within a specific range, and the matching unit detects that a credit or a debit has occurred in an amount beyond the specific range as a premonition.
(4) The credit and debit log analysis device may be configured such that the matching unit detects a new premonition using a premonition detected in the past.
(5) The credit and debit log analysis device is provided with an external data interface (e.g. external DB interface 151), which is connected with an external database. Meanwhile, the device may be also configured such that the matching unit inputs data concerning the customer of the analysis object other than the credit and debit data through the external database interface, and detects a new premonition by comparing a detected premonition with the data.
(6) The credit and debit log analysis device is provided with a business day administration unit (e.g. business day administration unit 111), which administers information concerning dates, on which a credit or a debit of the customer of the analysis object can be performed. Meanwhile, the device may be configured such that the calendar acquires the information from the business day administration unit, and the trend discovering unit, the matching rule generating unit, and the matching unit perform processing taking the information into consideration.
(7) The credit and debit log analysis device may be configured as follows:

Namely, the presentation unit displays premonitions extracted from the premonition storage unit, and in the event that a user designates a specific premonition, a matching rule, based on which the premonition was detected. The presentation unit may display: in the event that a user designates the matching rule, a trend, based on which the matching rule was generated; and in the event that a user designates the trend, a part of the credit and debit data, based on which the trend was discovered.

(8) The credit and debit log analysis device may be configured such that the presentation unit transmits a relevant premonition only to terminals of interested persons (e.g. terminal 131) defined in advance for each condition of a premonition.

### (Supplementary Note 1)

The credit and debit log analysis device may be configured such that the trend discovering unit discovers a trend that a credit or a debit occurs on a specific day, and the matching unit detects that a credit or a debit scheduled on the specific day has occurred on another day as a premonition.

### (Supplementary Note 2)

The credit and debit log analysis device may be configured such that the trend discovering unit discovers as a trend all customers, with whom a credit or a debit has been earned ever, and the matching unit detects as a premonition that a credit or a debit has occurred with a customer, with whom a credit and a debit have not been earned yet.

### (Supplementary Note 3)

The credit and debit log analysis device may be configured such that the trend discovering unit discovers as a trend occurrence of a credit or a debit in a specific amount, when a specific condition is met, and that the matching unit detects as a premonition occurrence of a credit or a debit in an amount different from the specific amount, when a specific condition is met.

### (Supplementary Note 4)

The credit and debit log analysis device may be configured such that the matching unit detects as a new premonition successive premonitions of the same Class appearing a predetermined number of times or more in premonitions having been detected in the past.

### (Supplementary Note 5)

The credit and debit log analysis device may be configured such that the matching unit can detect as a new premonition gradual increase in intervals between credit dates with respect to premonitions having been detected in the past.

### (Supplementary Note 6)

The credit and debit log analysis device may be configured such that the matching unit can detect as a new premonition gradual decrease in credit amounts, or gradual increase in credit amounts with respect to premonitions having been detected in the past.

### (Supplementary Note 7)

The credit and debit log analysis device may be configured such that the credit and debit log storage unit stores a class of a payment means as a part of the credit and debit log, and that the matching unit detects change in the payment means with respect to the same customer from a certain time point as a premonition.

### (Supplementary Note 8)

The credit and debit log analysis device may be configured as follows. Namely, the trend discovering unit discovers a trend of a monthly amount with respect to a transaction amount with a customer, or a total transaction amount of all customers. The matching unit may detect as a premonition a month in which there appears a difference equal to or more than a certain value between the monthly amount and the trend.

### (Supplementary Note 9)

The credit and debit log analysis device may be configured such that the matching unit detects a fluctuation of the number of premonitions during a specific period taking a pace of the fluctuation into consideration as a new premonition.

### (Supplementary Note 10)

The credit and debit log analysis device may be configured such that the trend unit discovers a credit or a debit earned not on a specific day but during every predetermined period as a trend taking the information administered by the business day administration unit into consideration.

### (Supplementary Note 11)

The credit and debit log analysis device is provided with a log restriction unit (e.g. log restriction unit 121) for restricting a credit and debit log extracted from the credit and debit log storage unit, and may be configured such that the trend discovering unit discovers a trend of a credit and a debit based on the restricted credit and debit log and the calendar.

### (Supplementary Note 12)

The credit and debit log analysis device may be configured such that, when a user designates a specific premonition, the presentation unit displays a past premonition, which was detected by the same matching rule based on which the designated premonition was detected.

### (Supplementary Note 13)

The credit and debit log analysis device may be configured such that, when a user designates a specific matching rule, the presentation unit displays a past premonition, which was detected by the matching rule.

### (Supplementary Note 14)

The credit and debit log analysis device may be configured such that the presentation unit receives a judgment of a user indicating whether a premonition is useful or not, and displays only the information judged as useful.

### (Supplementary Note 15)

The credit and debit log analysis device may be configured such that the presentation unit transmits a presenting content to terminals owned by interested persons to display the presenting content on the terminals.

This application claims the benefit of priority base on Japanese Patent Application No. 2012-157703 filed on 13 Jul. 2012, the entire disclosures of which are hereby incorporated by reference.

Although the present invention has been described referring to exemplary embodiments and Examples, it is to be understood that the present invention is not limited by such exemplary embodiments and Examples. To the constitution or details of the present invention many alternations conceivable by those skilled in the art can be added within the spirit and scope of the present invention.

### INDUSTRIAL APPLICABILITY

The present invention can be utilized by a bank for grasping deterioration of the business situation of a customer, or grasping the asset situation of an individual customer.

### REFERENCE SIGNS LIST

11 Credit and debit log storage unit
12 Trend discovering unit
13 Trend storage unit
14 Matching rule generating unit
15 Calendar
16 Matching rule storage unit
17 Matching unit
18 Premonition storage unit
19 Presentation unit
111 Business day administration unit
121 Log restriction unit
131 Terminal
151 External database interface

What is claimed is:

1. A credit and debit log analysis device comprising:
a credit and debit log storage unit that stores a history of credit to an account of a customer to be an analysis object and debit to the account as a credit and debit log;
a calendar that stores information on a date;
a trend discovering unit that discovers a trend of credit and debit based on the credit and debit log and the calendar;
a trend storage unit that stores the trend;
a matching rule generating unit that generates a matching rule based on the trend so as to detect credit and debit data contravening the trend;
a matching rule storage unit that stores the matching rule;
a matching unit that detects a premonition by comparing the credit and debit data and the matching rule;
a premonition storage unit that stores the premonition; and
a presentation unit that presents the premonition to a user.

2. The credit and debit log analysis device according to claim 1, wherein:
the trend discovering unit discovers a trend that a credit or a debit occurs on a specific day, and
the matching unit detects that a credit or a debit has not occurred on the specific day as a premonition.

3. The credit and debit log analysis device according to claim 1, wherein:
the trend discovering unit discovers a trend that a credit or a debit occurs in an amount within a specific range, and
the matching unit detects that a credit or a debit has occurred in an amount beyond the specific range as the premonition.

4. The credit and debit log analysis device according to claim 1, wherein the matching unit detects a new premonition using the premonition detected in the past.

5. The credit and debit log analysis device according to any one of claim 1 further comprising an external data interface, which is connected with an external database, wherein the matching unit inputs data concerning the customer of the analysis object other than the credit and debit data through the external data interface, and detects a new premonition by comparing a detected premonition with the data.

6. The credit and debit log analysis device according to claim 1 further comprising a business day administration unit, which administers information concerning dates, on which a credit and a debit of the customer of the analysis object can be performed, wherein:
the calendar acquires the information from the business day administration unit, and
the trend discovering unit, the matching rule generating unit, and the matching unit perform processing taking the information into consideration.

7. The credit and debit log analysis device according to claim 1, wherein:
the presentation unit displays the premonitions extracted from the premonition storage unit,
in the event that a user designates specific one out of the premonitions, the presentation unit displays a matching rule based on which the premonition was detected,
in the event that a user designates the matching rule, the presentation unit displays a trend based on which the matching rule was generated, and
in the event that a user designates the trend, the presentation unit displays a part of credit and debit data based on which the trend was discovered.

8. The credit and debit log analysis device according to claim 1, wherein the matching unit detects a monthly credit of a substantially same amount or an amount in a round number from a customer, with whom dealing has started newly, as a premonition.

9. The credit and debit log analysis device according to claim 1, wherein the matching unit detects a fluctuation of the number of premonitions during a specific period taking a pace of the fluctuation into consideration as a premonition.

10. The credit and debit log analysis device according to claim 1, wherein
the credit and debit log storage unit stores the class of payment means as a part of the credit and debit log, and
the matching unit detects a change of the payment means for a same customer from a certain time point as a premonition.

11. A credit and debit log analysis method, comprising:
storing a history of credit to an account of a customer to be an analysis object and debit to the account as a credit and debit log;
storing information on a date in a calendar;
discovering a trend of credit and debit based on the credit and debit log and the calendar;
string the trend;
generating a matching rule based on the trend so as to detect credit and debit data contravening the trend;
storing the matching rule;
detecting a premonition by comparing the credit and debit data and the matching rule;
storing the premonition; and
presenting the premonition to a user.

12. A non-transitory computer readable medium storing a credit and debit log analysis program causing a computer to execute:
a credit and debit log storage processing for storing a history of credit to an account of a customer to be an analysis object and debit to the account as a credit and debit log;
a processing for storing information on a date in a calendar;
a trend discovery processing for discovering a trend of credit and debit based on the credit and debit log and the calendar;
a trend storage processing for storing the trend;
a matching rule generation processing for generating a matching rule based on the trend so as to detect credit and debit data contravening the trend;
a matching rule storage processing for storing the matching rule;
a matching processing for detecting a premonition by comparing the credit and debit data and the matching rule;
a premonition storage processing for storing the premonition; and
a presentation processing for presenting the premonition to a user.
